(19) United States
(12) Patent Application Publication
(10) Pub. No.: US 2025/0039801 A1
(43) Pub. Date: Jan. 30, 2025

(54) USER EQUIPMENT AND BASE STATION IN COMMUNICATION SYSTEM AND METHODS PERFORMED BY USER EQUIPMENT AND BASE STATION

(71) Applicant: Samsung Electronics Co., Ltd., Suwon-si (KR)

(72) Inventors: Jingxing FU, Beijing (CN); Feifei SUN, Beijing (CN); Zhe CHEN, Beijing (CN)

(21) Appl. No.: 18/779,620

(22) Filed: Jul. 22, 2024

(30) Foreign Application Priority Data
Jul. 24, 2023 (CN) 202310913159.1

(51) Int. Cl. H04W 52/14

(52) U.S. Cl. CPC H04W 52/146

(57) ABSTRACT

The disclosure relates to a 5G or 6G communication system for supporting a higher data transmission rate. A method performed by a user equipment (UE) in a communication system is provided. The method includes determining a power control parameter, based on information on uplink and downlink frequency resource configuration for a physical uplink shared channel (PUSCH), determining a transmission power of the PUSCH, based on the determined power control parameter, and transmitting the PUSCH based on the determined transmission power.

### CROSS-REFERENCE TO RELATED APPLICATION(S)

This application is based on and claims priority under 35 U.S.C. § 119(a) of a Chinese patent application number 202310913159.1, filed on Jul. 24, 2023, in the Chinese Intellectual Property Office, the disclosure of which is incorporated by reference herein in its entirety.

### BACKGROUND

### 1. Field

The disclosure relates to the field of communication technology. More particularly, the disclosure relates to a user equipment (UE) and base station in a communication system and methods performed by the same.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources. 5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

In order to meet the increasing demand for wireless data communication services since the deployment of fourth generation (4G) communication systems, efforts have been made to develop improved fifth generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter wave (mmWave)) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

In a wireless communication system, a physical uplink shared channel (PUSCH) may have different uplink and downlink resource distributions in different time units, resulting in different interference in different time units, so that a power for transmitting the PUSCH by the UE needs to be augmented to control the power for transmitting the PUSCH more reasonably, so as to ensure performance of the PUSCH transmitted by the UE.

Aspects of the disclosure are to address at least the above-mentioned problems and/or disadvantages and to provide at least the advantages described below. Accordingly, an aspect of the disclosure is to provide a UE and base station in a communication system and methods performed by the same.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes determining a power control parameter, based on information on uplink and downlink frequency resource configuration for a physical uplink shared channel (PUSCH), determining a transmission power of the PUSCH, based on the determined power control parameter, and transmitting the PUSCH based on the determined transmission power.

In an embodiment, the determining of the power control parameter based on information on uplink and downlink frequency resource configuration for a PUSCH, includes receiving downlink control information (DCI) for scheduling the PUSCH, determining the uplink and downlink frequency resource configuration for the PUSCH based on the DCI, and determining the corresponding power control parameter based on the determined uplink and downlink frequency resource configuration for the PUSCH and a first corresponding relationship, the first corresponding relationship being indicating association between the uplink and downlink frequency resource configuration and the power control parameter.

In an embodiment, the first corresponding relationship is received via high-level signalling, the first corresponding relationship includes an index value, the information on the uplink and downlink frequency resource configuration for the PUSCH, and the power control parameter, where the determining a power control parameter includes receiving the index value, and determining the corresponding power control parameter based on the first corresponding relationship, based on the received index value and the determined uplink and downlink frequency resource configuration for the PUSCH.

In an embodiment, the uplink and downlink frequency resource configuration for the PUSCH is determined based on a domain which is included in the DCI and indicates the uplink and downlink frequency resource configuration for the PUSCH.

In an embodiment, the uplink and downlink frequency resource configuration for the PUSCH is determined based on frequency domain resource assignment (FDRA) information included in the DCI.

In an embodiment, the determining of the power control parameter based on information related to uplink and downlink frequency resource configuration for a PUSCH, includes determining the uplink and downlink frequency resource configuration for the PUSCH based on configuration and activation scheduling information for the PUSCH resource, and determining the corresponding power control parameter based on the determined uplink and downlink frequency resource configuration for the PUSCH and a second corresponding relationship, the second corresponding relationship indicating association between the uplink and downlink frequency resource configuration and the power control parameter.

In an embodiment, the configuration and activation scheduling information for the PUSCH resource includes configuration information for configured grant CG type 1 PUSCH and activation scheduling information for CG type 2 PUSCH.

In an embodiment, the determining of the power control parameter, based on information related to uplink and downlink frequency resource configuration for a PUSCH, includes determining, in the case where downlink control information (DCI) for scheduling the PUSCH is in a first DCI format and/or the number of PUSCHs scheduled by the DCI is greater than a threshold, the power control parameter based on the information on the uplink and downlink frequency resource configuration for the PUSCH.

In an embodiment, the method performed by a user equipment (UE) further includes determining, in the case where the DCI for scheduling the PUSCH is not in the first DCI format and/or the number of PUSCHs scheduled by the DCI is less than or equal to the threshold, the power control parameter, includes receiving an index value, and determining the corresponding power control parameter based on the received index value and a third corresponding relationship, the third corresponding relationship including the index value and the power control parameter.

In an embodiment, the index value includes a sounding reference signal (SRS) resource indicator (SRI) field value or open-loop power control parameter set indication (OPCI).

In an embodiment, the determining a power control parameter based on information related to uplink and downlink frequency resource configuration for a PUSCH, includes determining, in the case of receiving indication via high-level signalling, the power control parameter based on the information on the uplink and downlink frequency resource configuration for the PUSCH.

In an embodiment, the indication received via high-level signalling includes information on a corresponding relationship indicating association between the uplink and downlink frequency resource configuration and the power control parameter.

In an embodiment, the indication received via high-level signalling includes indication information indicating that the power control parameter is determined based on the information on the uplink and downlink frequency resource configuration for the PUSCH. The indication information may be 1-bit information.

In accordance with another aspect of the disclosure, a method performed by a user equipment (UE) in a communication system is provided. The method includes receiving N sets of power control parameters via high-level signalling, N being greater than or equal to 4, determining a set of power control parameters from the N sets of power control parameters based on open-loop power control parameter set indication (OPCI), determining a transmission power of a physical uplink shared channel (PUSCH) based on the determined power control parameters, and transmitting the PUSCH based on the determined transmission power.

In an embodiment, the OPCI is 2 bits or 3 bits.

In accordance with another aspect of the disclosure, a user equipment (UE) in a wireless communication system is provided. The UE includes a transceiver, and a processor coupled to the transceiver and configured to determine a power control parameter, based on information on uplink and downlink frequency resource configuration for a physical uplink shared channel (PUSCH), determine a transmission power of the PUSCH, based on the determined power control parameter, and transmit the PUSCH based on the determined transmission power.

In accordance with another aspect of the disclosure, a method performed by a base station in a communication system is provided. The method includes transmitting, to a user equipment (UE), information on uplink and downlink frequency resource configuration for a physical uplink shared channel (PUSCH), and receiving, from the UE, the PUSCH, wherein the PUSCH is transmitted by the UE based on a transmission power determined by the information on the uplink and downlink frequency resource configuration for the PUSCH.

In accordance with another aspect of the disclosure, a method performed by a base station in a communication system is provided. The method includes transmitting, to a user equipment (UE), N sets of power control parameters via high-level signalling, N being greater than or equal to 4, transmitting, to the UE, open-loop power control parameter set indication OPCI, and receiving, from the UE, a physical uplink shared channel PUSCH, wherein the PUSCH is transmitted by the UE based on a transmission power determined by a power control parameter indicated by the OPCI.

In accordance with another aspect of the disclosure, a base station in a wireless communication system is provided. The base station includes a transceiver, and a processor coupled to the transceiver and configured to transmit, to a user equipment (UE), information on uplink and downlink frequency resource configuration for a physical uplink shared channel (PUSCH), and receive, from the UE, the PUSCH, wherein the PUSCH is transmitted by the UE based on a transmission power determined by the information on the uplink and downlink frequency resource configuration for the PUSCH.

In accordance with another aspect of the disclosure, a base station in a wireless communication system is provided. The base station includes a transceiver, and a processor coupled to the transceiver and configured to transmit, to a user equipment (UE), N sets of power control parameters via high-level signalling, N being greater than or equal to 4, transmit, to the UE, open-loop power control parameter set indication (OPCI), and receive, from the UE, a physical uplink shared channel (PUSCH), wherein the PUSCH is transmitted by the UE based on a transmission power determined by a power control parameter indicated by the OPCI.

In accordance with another the disclosure, one or more non-transitory a computer readable storage media storing one or more computer programs including computer-executable instructions that, when executed by one or more processors of a user equipment (UE) individually or collectively, cause the UE to perform operations is provided. The operations include determining a power control parameter, based on information on uplink and downlink frequency resource configuration for a physical uplink shared channel (PUSCH), determining a transmission power of the PUSCH, based on the determined power control parameter, and transmitting the PUSCH based on the determined transmission power.

On the one hand, by using the technical solution of the disclosure, the power for transmitting the PUSCH by the UE may be controlled more reasonably by using the information on the uplink and downlink frequency resource configuration for the PUSCH, so as to ensure the performance of the PUSCH transmitted by the UE.

On the other hand, by using the technical solution of the disclosure, the open-loop power control parameter set indication (OPCI) may be used to contain a larger amount of information, and the power for transmitting the PUSCH by the UE may be more reasonably controlled through the OPCI, so as to ensure that the performance of the PUSCH sent by the UE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an example wireless network according to an embodiment of the disclosure;

FIGS. 2A and 2B respectively illustrate example wireless transmission and reception paths according to various embodiments of the disclosure;

FIG. 3A is a block diagram of a composition and structure of a user equipment according to an embodiment of the disclosure;

FIG. 3B is a block diagram of a composition and structure of a base station according to an embodiment of the disclosure;

FIG. 4 illustrates assignment of uplink and downlink transmission resources according to an embodiment of the disclosure;

FIG. 5 is a flowchart of a method performed by a user equipment, according to an embodiment of the disclosure;

FIG. 6 illustrates an example of uplink and downlink frequency resource configuration for a PUSCH according to an embodiment of the disclosure;

FIG. 7 illustrates another example of uplink and downlink frequency resource configuration for a PUSCH according to an embodiment of the disclosure;

FIG. 8 is a flowchart of a method performed by a user equipment, according to an embodiment of the disclosure; and

FIG. 9 illustrates a structure of a user equipment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

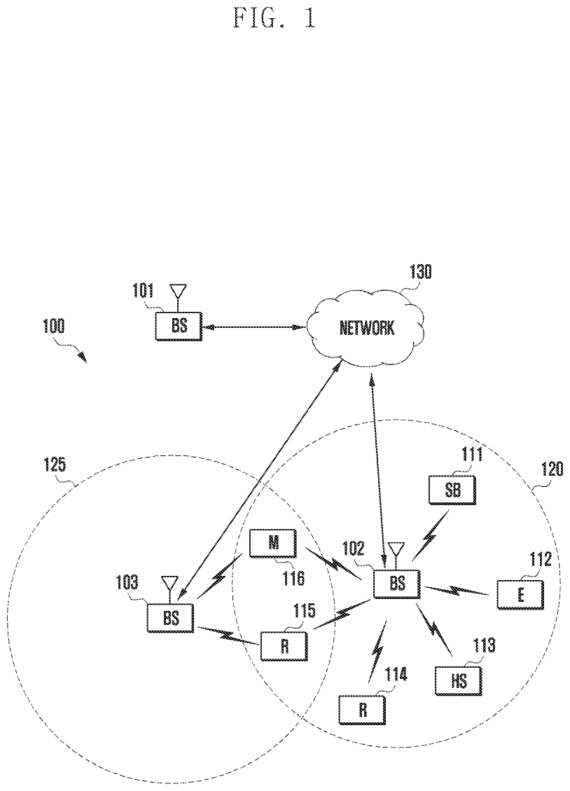

FIG. 1 illustrates an example wireless network 100 according to an embodiment of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. The terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipments (UEs) within a coverage area 120 of the gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of the gNB 103. The second plurality of UEs include a UE 115 and a UE 116. In some embodiments, one or more of the gNBs 101-103 can communicate with each other and with UEs 111-116 using 5G, Long Term Evolution (LTE), long term evolution advanced (LTE-A), worldwide interoperability for microwave access (WiMAX) or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a two-dimensional (2D) antenna array as described in various embodiments of the disclosure. In some embodiments, one or more of the gNB 101, the gNB 102, and the gNB 103 support codebook designs and structures for systems with 2D antenna arrays.

Although FIG. 1 illustrates an example of the wireless network 100, various changes can be made to FIG. 1. The wireless network 100 can include any number of the gNBs and any number of UEs in any suitable arrangement, for example. Furthermore, the gNB 101 can directly communicate with any number of UEs and provide wireless broadband access to the network 130 for those UEs. Similarly, each the gNB 102-103 can directly communicate with the network 130 and provide direct wireless broadband access to the network 130 for the UEs. In addition, the gNB 101, 102 and/or 103 can provide access to other or additional external networks, such as external telephone networks or other types of data networks.

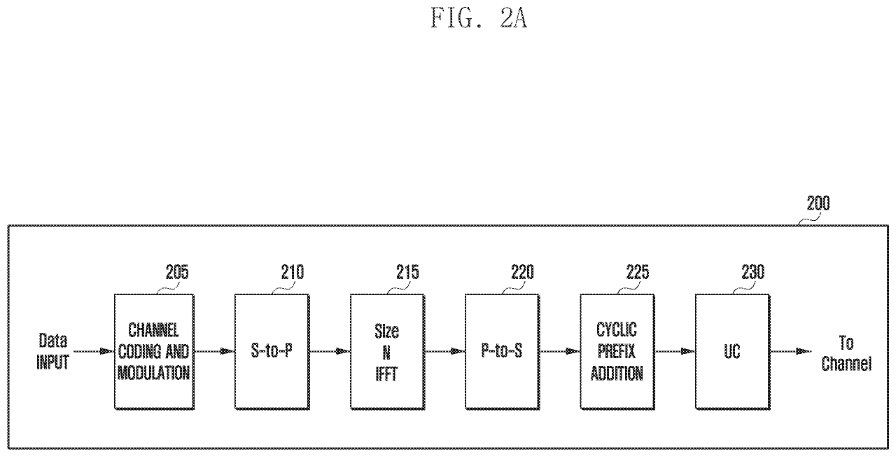

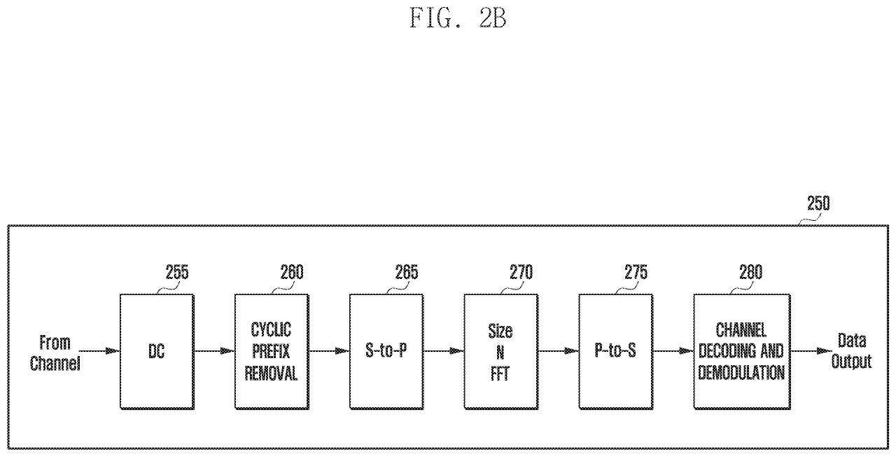

FIGS. 2A and 2B illustrate example wireless transmission and reception paths according to various embodiments of the disclosure.

In the following description, the transmission path 200 can be described as being implemented in a gNB, such as the gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in various embodiments of the disclosure.

The transmission path 200, for example, includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in the gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225, for example, inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from the gNB 102 arrives at UE 116 after passing through the wireless channel, and operations in reverse to those at the gNB 102 are performed at UE 116. The down-converter 255, for example, down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

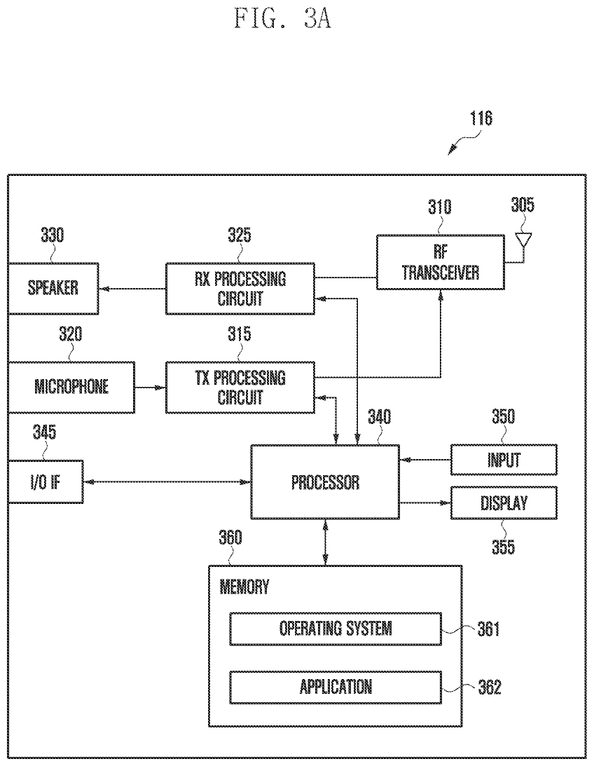

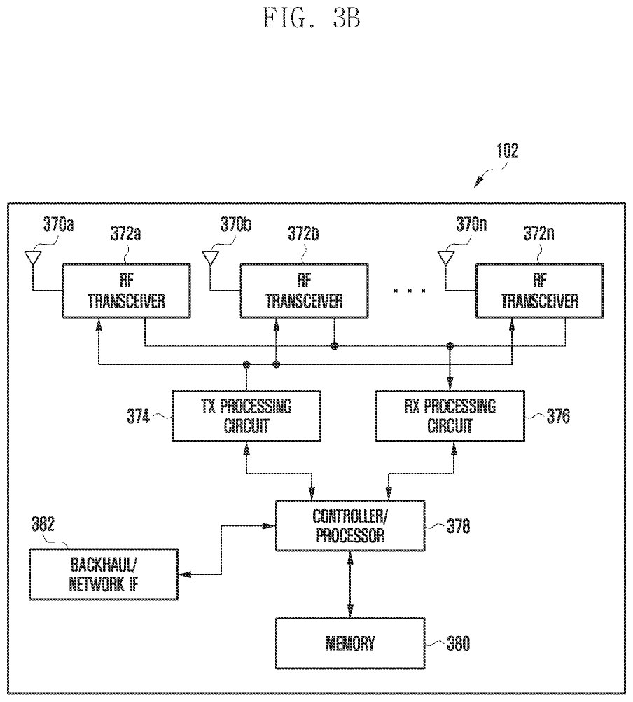

FIG. 3A illustrates an example UE 116 according to an embodiment of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325, for example, transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In various embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in various embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example of the gNB 102 according to an embodiment of the disclosure. The embodiment of the gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that the gNB 101 and the gNB 103 can include the same or similar structures as the gNB 102.

Referring to FIG. 3B, the gNB 102 includes a plurality of antennas 370a, 370b, . . . 370n, a plurality of RF transceivers 372a, 372b, . . . 372n, a transmission (TX) processing circuit 374, and a reception (RX) processing circuit 376. In certain embodiments, one or more of the plurality of antennas 370a, 370b, . . . 370n include a 2D antenna array. The gNB 102 also includes a controller/processor 378, memory 380, and a backhaul or network interface 382.

RF transceivers 372a, 372b, . . . 372n receive an incoming RF signal from antennas 370a, 370b, . . . 370n, such as a signal transmitted by UEs or other gNBs. RF transceivers 372a, 372b, . . . 372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a, 372b, . . . 372n receive the outgoing processed baseband or IF signal from TX processing circuit 374 and up-convert the baseband or IF signal into an RF signal transmitted via antennas 370a, 370b, . . . 370n.

The controller/processor 378 can include one or more processors or other processing devices that control the overall operation of gNB 102. For example, the controller/processor 378 can control the reception of forward channel signals and the transmission of backward channel signals through the RF transceivers 372a, 372b, . . . 372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in various embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of the gNB 102 (implemented using RF transceivers 372a, 372b, . . . 372n, TX processing circuit 374 and/or RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

Various embodiments of the disclosure are further described below in combination with the accompanying drawings.

Communication systems include time domain duplexing (TDD) systems and frequency domain duplexing (FDD) systems. In a TDD system, a base station may configure uplink and downlink attributes in different time resources on a carrier, e.g., uplink transmission slots/symbols (such as OFDM symbols), downlink transmission slots/symbols, and flexible slots/symbols, by semi-static signalling as well as dynamic signalling. In an FDD system, a base station may configure, in a pair of uplink and downlink carriers, different time resources of an uplink carrier as uplink transmission slots/symbols or flexible slots/symbols, and different time resources of a downlink carrier as downlink transmission slots/symbols or flexible slots/symbols, respectively.

Semi-static signalling may be high-level signalling. Dynamic signalling may be group-common downlink control information (DCI) that does not schedule physical downlink shared channels (PDSCH) and physical uplink shared channels (PUSCH). Dynamic signalling may also be DCI that schedules physical downlink shared channels (PDSCH) and physical uplink shared channels (PUSCH). Here, the PUSCH may be either one-time PUSCH or PUSCH repetition.

Compared to FDD systems, a time delay of uplink or downlink transmission is relatively large in TDD systems, since the uplink and downlink transmission is time-domain multiplexed. For example, according to one uplink and downlink configuration, in a 10 ms (milliseconds) period, only 1 ms slot is uplink transmission, all other slots are downlink transmission or flexible transmission, and the time delay of uplink transmission is 10 ms at maximum. In order to reduce the transmission delay, it may be considered to configure part of frequency domain resources in a carrier as uplink transmission, and other part of the resources as downlink transmission. In order to reduce mutual influence of uplink and downlink transmission in the same carrier, uplink and downlink interference may be reduced by means of a protection interval.

Based on the uplink and downlink transmission method described in various embodiments of the disclosure, data transmission performance may be ensured and the resources can be fully used as much as possible while ensuring the data transmission performance.

In the TDD systems, the base station may indicate that a time unit (e.g., a time unit including one or more slots, or one or more symbols) is an uplink slot/symbol, or a downlink slot/symbol, or a flexible transmission slot/symbol. In the following description, “time unit”, “slot”, and “symbol” are used interchangeably. The UE determines an uplink and downlink transmission direction for each symbol/slot of a carrier/service cell based on indication of the base station. Typically, only one direction of transmission, i.e., uplink or downlink transmission, is supported in the same symbol of a carrier/service cell, so that the base station only needs to indicate the uplink and downlink transmission direction in a time dimension. The base station may indicate periodically, e.g., by high-level signalling to indicate a periodic slot configuration, or by dynamic signalling to indicate a slot format over a period of time, or by scheduling to indicate whether the scheduled resource is suitable for uplink transmission or downlink reception. The uplink and downlink attributes of the frequency domain resources within each slot/symbol are determined by slot configuration/format: for uplink transmission, for downlink transmission, or for flexible transmission. Flexible slots/symbols may be used for both uplink transmission and downlink transmission, but only for one of these directions at a given moment.

In FDD systems, the base station may indicate uplink or flexible transmission symbols/slots for uplink carriers/service cells, and downlink or flexible transmission symbols/slots for downlink carriers/service cells. Type 1 cell common UpLink (UL)/DownLink (DL) information may include information on uplink and downlink attributes in the time dimension, and Type 1 cell common UL/DL information may be used to indicate the period, which slots/symbols within the period are uplink, downlink, or flexible slots/symbols, respectively, and that the uplink and downlink attributes indicated are applicable to all frequency domain resources within the slots/systems of this cell. For example, all frequency domain resources within this carrier/service cell bandwidth have the same uplink and downlink attributes within a slot/symbol.

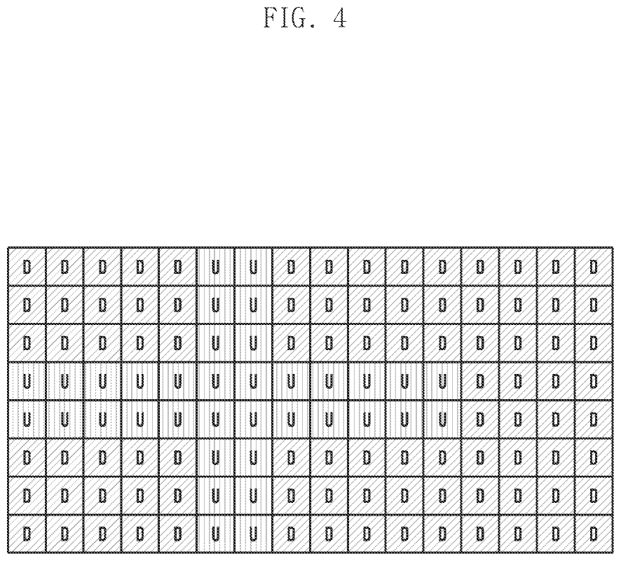

For more efficient assignment of uplink and downlink transmission resources, granularity of the uplink and downlink transmission resources may be further reduced from all frequency domain resources in one symbol/slot to some of the frequency domain resources within one symbol/slot by using configuration information, e.g., different frequency domain resources in one symbol of a carrier/service cell may be configured with different transmission directions. The configuration information includes cell common UL/DL information and/or UE-specific UL/DL information. The cell common UL/DL information may, for example, include information on the uplink and downlink attributes in both the time dimension and a frequency domain dimension. For example, the cell common UL/DL information may be used to indicate which frequency domain resources of which slots/symbols are uplink, downlink, or flexible transmission resources; alternatively, the cell common UL/DL information may be used to indicate which frequency domain resources of which slots/symbols are uplink, downlink resources, or resources that cannot be used for transmission. The base station may also configure user-specific UL/DL information, e.g., user-specific UL/DL information for each service cell of the UE, or user-specific UL/DL information for each BWP (Bandwidth Part) of the UE. The UE, based on the configured UL/DL information, may determine that within a symbol or slot, part of the frequency domain resources are uplink transmission resources and part of the frequency domain resources are downlink transmission resources, as shown in FIG. 4.

FIG. 4 illustrates assignment of uplink and downlink transmission resources according to an embodiment of the disclosure.

It may also be determined that within a symbol or slot, all frequency domain resources are uplink transmission resources, or it may be determined that within a symbol or slot, all frequency domain resources are downlink transmission resources. The configuration information may be semi-static signalling, e.g., high-level signalling.

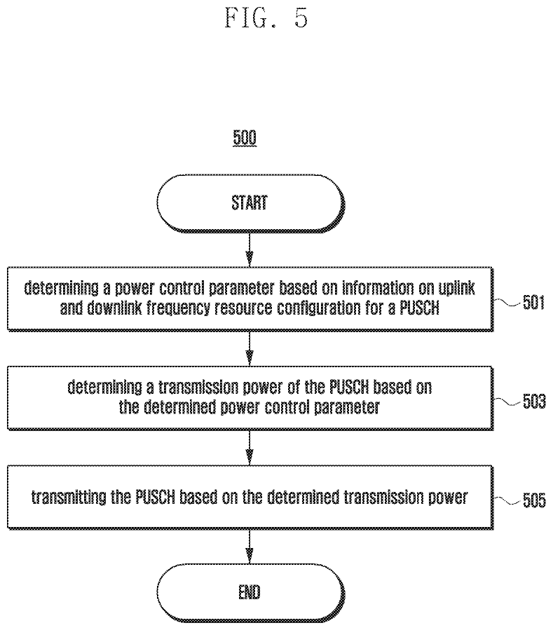

FIG. 5 is a flowchart of a method performed by a user equipment, according to an embodiment of the disclosure.

In a method 500 as shown in FIG. 5, in operation 501, determining a power control parameter, based on information on uplink and downlink frequency resource configuration for a PUSCH; in operation 503, determining a transmission power of the PUSCH, based on the determined power control parameter; and in operation 505, transmitting the PUSCH based on the determined transmission power.

By using the method shown in FIG. 5, the information on the uplink and downlink frequency resource configuration for the PUSCH may be used to control the power for transmitting the PUSCH by the UE more reasonably, so as to ensure performance of the PUSCH sent by the UE.

In an embodiment, the UE may receive downlink control information (DCI) for scheduling the PUSCH, determine the uplink and downlink frequency resource configuration for the PUSCH based on the DCI, and then determine the corresponding power control parameter based on the determined uplink and downlink frequency resource configuration for the PUSCH and a first corresponding relationship. The first corresponding relationship is used to indicate association between the uplink and downlink frequency resource configuration and the power control parameter.

Through the embodiment, the DCI for scheduling the PUSCH may be used to determine the uplink and downlink frequency resource configuration for the PUSCH, and the power for transmitting the PUSCH by the UE may be more reasonably controlled based on the first corresponding relationship by the determined uplink and downlink frequency resource configuration for the PUSCH, so as to ensure the performance of the PUSCH sent by the UE.

The following is a detailed description of using a DCI scheduling at least one PUSCH as an example.

The uplink and downlink frequency resource configuration for the PUSCH may include an uplink and downlink frequency domain resource distribution state of the PUSCH, and according to the embodiment, the power for transmitting the PUSCH may be determined based on the uplink and downlink frequency domain resource distribution state of the PUSCH and scheduling information for the PUSCH resource (e.g., DCI for scheduling the PUSCH).

It may be understood that an independent power control parameter may be configured for each uplink and downlink frequency domain resource distribution state, and the power control parameter may include an open-loop power control parameter and/or a closed-loop power control parameter, the open-loop power control parameter may include P_{O_UE_PUSCH,b,f,c}(j) and/or α_{b,f,c}(j) or the like, and the closed-loop power control parameter may include δ_{PUSCH,b,f,c}(i,l) or the like.

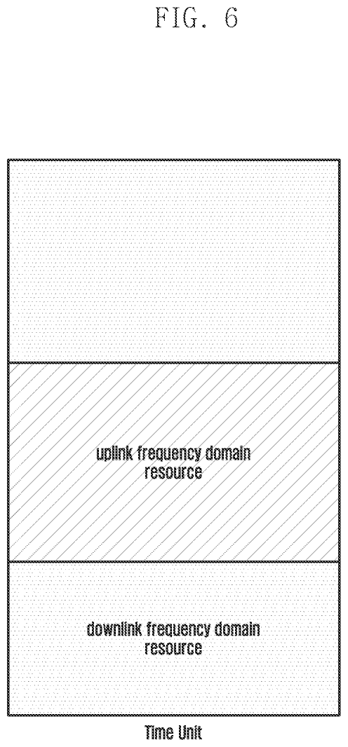

FIG. 6 illustrates an example of uplink and downlink frequency resource configuration for a PUSCH according to an embodiment of the disclosure.

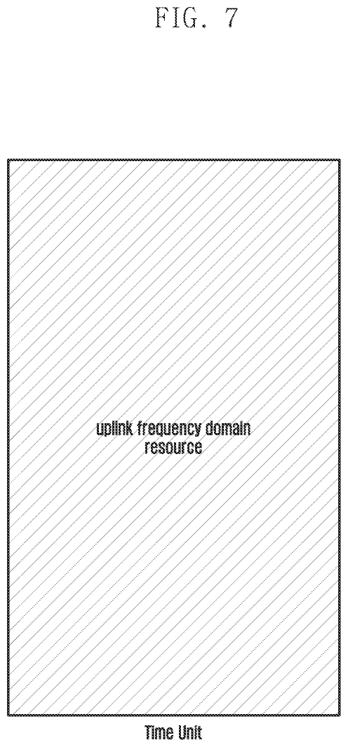

FIG. 7 illustrates another example of uplink and downlink frequency resource configuration for a PUSCH according to an embodiment of the disclosure.

The following describes two uplink and downlink frequency domain resource distribution states as an example, in which a first uplink and downlink frequency domain resource distribution state is that a part of the frequency domain resources are downlink frequency domain resources and a part of the frequency domain resources are uplink frequency domain resources in a time unit, as shown in FIG. 6; and a second uplink and downlink frequency domain resource distribution state is that all the frequency domain resources are uplink frequency domain resources in a time unit, as shown in FIG. 7. It may be understood that although the method below is illustrated with 2 uplink and downlink frequency domain resource distribution states as an example, the method is equally applicable in the case of more than 2 uplink and downlink frequency domain resource distribution states.

The UE may receive, via high-level signalling, a corresponding relationship used to indicate the association between the uplink and downlink frequency resource configuration and the power control parameter, for example, as shown in Table 1, the corresponding relationship may include an index value, the information related to the uplink and downlink frequency resource configuration for the PUSCH, and the power control parameter.

As shown in Table 1, when the index value is “0” and the uplink and downlink frequency domain resource distribution state is the first uplink and downlink frequency domain resource distribution state, the parameter P_{0_UE_PUSCH,b,f,c}_1_1 is used for power control; when the index value is “0” and the uplink and downlink frequency domain resource distribution state is the second uplink and downlink frequency domain resource distribution state, the parameter P_{0_UE_PUSCH,b,f,c}_1_2 is used for power control. When the index value is “1” and the uplink and downlink frequency domain resource distribution state is the first uplink and downlink frequency domain resource distribution state, the parameter P_{0_UE_PUSCH,b,f,c}_2_1 is used for power control; when the index value is “1” and the uplink and downlink frequency domain resource distribution state is the second uplink and downlink frequency domain resource distribution state, the parameter P_{0_UE_PUSCH,b,f,c}_2_2 is used for power control. This example is illustrated with 2 index values, and it may be understood that the number of index values may also be greater than two.

TABLE 1
correspondence table between index
value and power control parameter

| | first uplink and downlink | second uplink and downlink |
|---|---|---|
| | frequency domain resource | frequency domain resource |
| | distribution state (which may | distribution state (which may |
| index | also be referred to as first | also be referred to as second |
| value | set of power control parameters) | set of power control parameters) |
| 0 | P₀_{_{—}}_{UE}_{_{—}}_{PUSCH, b, f, c —}1_1 | P₀_{_{—}}_{UE}_{_{—}}_{PUSCH, b, f, c —}1_2 |
| 1 | P₀_{_{—}}_{UE}_{_{—}}_{PUSCH, b, f, c —}2_1 | P₀_{_{—}}_{UE}_{_{—}}_{PUSCH, b, f, c —}2_2 |

When the corresponding relationship used to indicate the association between the uplink and downlink frequency resource configuration and the power control parameter as shown in Table 1 is received via high-level signalling, the UE may receive the index value and then determine the corresponding power control parameter based on the received index value and the determined uplink and downlink frequency resource configuration for the PUSCH, based on the corresponding relationship as shown in Table 1.

The index value may be, for example, a sounding reference signal (SRS) resource indicator (SRI) field value. The index value may also be, for example, an open-loop power control parameter set indication field value.

The UE may determine the uplink and downlink frequency resource configuration for the PUSCH based on the DCI for scheduling the PUSCH.

According to an embodiment, the DCI for scheduling the PUSCH may include a domain used to indicate the uplink and downlink frequency resource configuration for the PUSCH.

As an example, it may be determined by using indication in the DCI for scheduling the PUSCH that is dedicated to indicating the uplink and downlink frequency domain resource distribution state, for example, it may be indicated by using a bitmap. The bitmap includes M bits, M being a positive integer, which is obtained by the UE via receiving signalling, and each bit in the bitmap corresponds to a PUSCH, e.g., a bit value of “0” indicates that the frequency domain resource of the corresponding PUSCH is in the first uplink and downlink frequency domain resource distribution state, and a bit value of “1” indicates that the frequency domain resource of the corresponding PUSCH is in the second uplink and downlink frequency domain resource distribution state. The first bit in the bitmap corresponds to the first PUSCH, and so on, the Mth bit in the bitmap corresponds to the Mth PUSCH.

As another example, it may be determined by using indication in the DCI for scheduling the PUSCH that is dedicated to indicating the uplink and downlink frequency domain resource distribution state, for example, the indication may be 1 bit. The UE obtains the 1-bit indication by receiving signalling, which indicates the power control parameters of all PUSCHs scheduled by the DCI. For example, when the bit value is “0”, all PUSCH frequency domain resources are in the first (or second) uplink and downlink frequency domain resource distribution state; when the bit value is “1”, all PUSCH frequency domain resources are in the second (or first) uplink and downlink frequency domain resource distribution state.

By determining the power control parameter based on the domain included in the DCI used to indicate the uplink and downlink frequency resource configuration for the PUSCH, power control may be performed accurately by using the existing information to indicate the uplink and downlink frequency domain resource distribution state.

According to another embodiment, the DCI for scheduling the PUSCH may include a domain capable of implicitly indicating the uplink and downlink frequency resource configuration for the PUSCH.

The DCI for scheduling the PUSCH may include information capable of implicitly determining the uplink and downlink frequency domain resource distribution state. For example, the uplink and downlink frequency domain resource distribution state of the scheduled PUSCH may be determined by frequency domain resource assignment (FDRA) information. Taking the two uplink and downlink frequency domain resource distribution states shown in FIGS. 6 and 7 as an example, when the FDRA has a value a, the frequency domain resource of the PUSCH is in the first uplink and downlink frequency domain resource distribution state, and when the FDRA has a value b, the frequency domain resource of the PUSCH is in the second uplink and downlink frequency domain resource distribution state. It may be understood that the FDRA may also correspond to more than 2 uplink and downlink frequency domain resource distribution states, and the uplink and downlink frequency resource configuration for the PUSCH may be determined by the specific value of the FDRA in the DCI.

By determining power control based on the domain capable of implicitly indicating the uplink and downlink frequency resource configuration for the PUSCH, power control may be performed accurately even when the UE does not receive the information used to indicate the uplink and downlink frequency domain resource distribution state.

It may be understood that the uplink and downlink frequency resource configuration for the PUSCH may also be determined by other signalling than the DCI for scheduling the PUSCH. The UE may obtain the uplink and downlink frequency domain resource distribution state of the PUSCH by receiving semi-static signalling, for example, high-level signalling.

According to an embodiment, the power control parameter may be determined based on the information related to the uplink and downlink frequency resource configuration for the PUSCH, if specific conditions are met, otherwise other methods for determining the power control parameter may be used.

For example, one of the following Mode 1 or Mode 2 may be selected for power control.

Mode 1. Determining the power for transmitting the PUSCH based on the determined uplink and downlink frequency domain resource distribution state in conjunction with the scheduling information for the PUSCH resource, e.g., determining the power control parameter based on the information related to the uplink and downlink frequency resource configuration for the PUSCH; and

Mode 2. Determining the power for transmitting the PUSCH based on the scheduling information for the PUSCH resource.

For example, the UE may receive, via high-level signalling, the corresponding relationship including the index value, the information related to the uplink and downlink frequency resource configuration for the PUSCH, and the power control parameter, as described above and shown in Table 1, and the UE may also receive, via high-level signalling, a corresponding relationship including the index value and the power control parameter, as shown in Table 2.

TABLE 2
correspondence table between index
value and power control parameter

| index value | power control parameter |
|---|---|
| 0 | P₀_{_{—}}_{UE}_{_{—}}_{PUSCH, b, f, c —}1 |
| 1 | P₀_{_{—}}_{UE}_{_{—}}_{PUSCH, b, f, c —}2 |

Power control may be performed by selecting Mode 1 or Mode 2 according to the format of the DCI for scheduling the PUSCH.

In the case where the DCI for scheduling the PUSCH is in the first DCI format, the power control parameter may be determined based on the information related to the uplink and downlink frequency resource configuration for the PUSCH (Mode 1). Then, based on the determined power control parameter, the transmission power of the PUSCH may be determined, and the PUSCH may be transmitted based on the determined transmission power.

As a specific example, when the DCI for scheduling the PUSCH is in the DCI format 0_x, Mode 1 is selected for power control. The DCI format 0_x may be at least one of 0_0, 0_1, or 0_2, and the UE may determine 0_x by receiving signalling or according to a preset protocol, e.g., the UE determines that 0_x is 0_1 according to a preset protocol; or the UE determines that 0_x is 0_1 or 0_2 according to a preset protocol. When the format of the DCI for scheduling the PUSCH is DCI format 0_y, Mode 2 is selected for power control The DCI format 0_y may be at least one of 0_0, 0_1, or 0_2, and the UE may determine 0_y by receiving signalling or according to a preset protocol, e.g., the UE determines that 0_y is 0_0, 0_2 by receiving signalling; or the UE determines that 0_y is 0_0 according to a preset protocol. The DCI format 0_x or 0_y may be determined by receive signalling or may be predefined.

Through the embodiment, the power control parameter may be accurately determined for power control without additional signalling.

As another example, power control may be performed by selecting Mode 1 or Mode 2 based on the number of PUSCHs scheduled by the DCI for scheduling the PUSCH.

In the case where the number of PUSCHs scheduled by the DCI for scheduling the PUSCH is greater than a threshold, the power control parameter may be determined based on the information related to uplink and downlink frequency resource configuration for the PUSCH (Mode 1). Then, based on the determined power control parameter, the transmission power of the PUSCH may be determined, and the PUSCH may be transmitted based on the determined transmission power.

As another example, when the number of PUSCHs scheduled by one DCI for scheduling the PUSCH is greater than L, Mode 1 is selected for power control; when the number of PUSCHs scheduled by one DCI for scheduling the PUSCH is less than or equal to L, Mode 2 is selected for power control. Here, L may be a positive integer, and the UE may receive signalling configuration or protocol presetting to determine L. For example, the UE may determine that L is equal to 1 by protocol presetting.

Through the embodiment, the power control parameter may be accurately determined for power control without additional signalling.

It may be understood that power control may also be performed by selecting Mode 1 or Mode 2 based on the format of the DCI for scheduling the PUSCH and the number of PUSCHs scheduled by the DCI.

For example, in the case where the DCI for scheduling the PUSCH is in the first DCI format and the number of PUSCHs scheduled by the DCI is greater than the threshold, the power control parameter may be determined based on the information related to uplink and downlink frequency resource configuration for the PUSCH (Mode 1). Based on the determined power control parameter, the transmission power of the PUSCH may be determined, and the PUSCH may be transmitted based on the determined transmission power.

It may be understood that in the case where the DCI for scheduling the PUSCH is not in the first DCI format and/or the number of PUSCHs scheduled by the DCI is less than or equal to the threshold, the power control parameter may be determined by the above corresponding relationship as shown in Table 2. For example, the UE may receive the index value and then determine the corresponding power control parameter based on the received index value and the corresponding relationship as shown in Table 2.

The index value may be, for example, a sounding reference signal (SRS) resource indicator (SRI) field value. The index value may also be, for example, an open-loop power control parameter set indication field value.

According to an embodiment, the power control parameter may be determined based on the information related to the uplink and downlink frequency resource configuration for the PUSCH, where the indication is received via high-level signalling, otherwise other methods for determining the power control parameter may be used.

According to another embodiment, the indication received via high-level signalling may include information related to a corresponding relationship used to indicate association between the uplink and downlink frequency resource configuration and the power control parameter. According to yet another embodiment, the indication received via high-level signalling may include indication used to indicate determining the power control parameter based on the information related to the uplink and downlink frequency resource configuration for the PUSCH. The indication may be 1-bit information.

For example, one of the following Mode 1 or Mode 2 may be selected for power control.

Mode 1. Determining the power for transmitting the PUSCH based on the determined uplink and downlink frequency domain resource distribution state in conjunction with the scheduling information for the PUSCH resource, e.g., determining the power control parameter based on the information related to the uplink and downlink frequency resource configuration for the PUSCH; and

Mode 2. Determining the power for transmitting the PUSCH based on the scheduling information for the PUSCH resource.

The UE may receive, via high-level signalling, the corresponding relationship including the index value, the information related to the uplink and downlink frequency resource configuration for the PUSCH, and the power control parameter, as described above and shown in Table 1, and the UE may also receive, via high-level signalling, the corresponding relationship including the index value and the power control parameter, as shown in Table 2.

As an example, if the UE receives the information related to the corresponding relationship used to indicate the association between the uplink and downlink frequency resource configuration and the power control parameter, power control is performed according to Mode 1, e.g., by determining the power control parameter based on the information related to the uplink and downlink frequency resource configuration for the PUSCH. The information related to the corresponding relationship used to indicate the association between the uplink and downlink frequency resource configuration and the power control parameter may be the corresponding relationship used to indicate the association between the uplink and downlink frequency resource configuration and the power control parameter as shown in Table 1. In this case, if the UE receives Table 1, the power control parameter may be determined based on the information related to the uplink and downlink frequency resource configuration for the PUSCH. If the UE does not receive Table 1, power control is performed according to Mode 2.

If the UE receives the indication used to indicate determining the power control parameter based on the information related to the uplink and downlink frequency resource configuration for the PUSCH, for example, indicating a configuration in which the power for transmitting the PUSCH is determined based on the determined uplink and downlink frequency domain resource distribution state in conjunction with the scheduling information for the PUSCH resource, then the power for transmitting the PUSCH is determined based on the determined uplink and downlink frequency domain resource distribution state in conjunction with the scheduling information for the PUSCH resource. If the UE does not receive the configuration in which the power for transmitting the PUSCH is determined based on the determined uplink and downlink frequency domain resource distribution state in conjunction with the scheduling information for the PUSCH resource, then the power for transmitting the PUSCH may be determined based on the scheduling information for the PUSCH resource. The indication may be 1-bit information. For example, when the indication is 0, the power for transmitting the PUSCH may be determined based on the determined uplink and downlink frequency domain resource distribution state in conjunction with the scheduling information for the PUSCH resource (Mode 1); when the indication is 1, the power for transmitting the PUSCH may be determined based on the scheduling information for the PUSCH resource (Mode 2).

According to the embodiment, determining the power control parameter based on the information related to the uplink and downlink frequency resource configuration for the PUSCH when the indication is received via high-level signalling, enables flexibility in determining whether or not to use the information related to the uplink and downlink frequency resource configuration for the PUSCH for power control.

According to another embodiment, power control for a configured grant (CG) PUSCH may be performed by determining the uplink and downlink frequency resource configuration for the PUSCH based on configuration and activation scheduling information for the PUSCH resource, then the power control parameter may be determined based on the determined uplink and downlink frequency resource configuration for the PUSCH and a second corresponding relationship. Here, the second corresponding relationship is used to indicate association between the uplink and downlink frequency resource configuration and the power control parameter.

According to still another embodiment, the configuration and activation scheduling information for the PUSCH resource may include configuration information for configured grant CG type 1 PUSCH and activation scheduling information for CG type 2 PUSCH.

As described above, an independent power control parameter may be configured for each uplink and downlink frequency domain resource distribution state, and the power control parameter may include an open-loop power control parameter and/or a closed-loop power control parameter, the open-loop power control parameter may include P_{O_UE_PUSCH,b,f,c}(j) and/or α_{b,f,c}(j) or the like, and the closed-loop power control parameter may include δ_{PUSCH,b,f,c}(i,l) or the like.

The following describes two uplink and downlink frequency domain resource distribution states as an example, in which a first uplink and downlink frequency domain resource distribution state is that a part of the frequency domain resources are downlink frequency domain resources and a part of the frequency domain resources are uplink frequency domain resources in a time unit, as shown in FIG. 6; and a second uplink and downlink frequency domain resource distribution state is that all the frequency domain resources are uplink frequency domain resources in a time unit, as shown in FIG. 7. It may be understood that although the method below is illustrated with 2 uplink and downlink frequency domain resource distribution states as an example, the method is equally applicable in the case of more than 2 uplink and downlink frequency domain resource distribution states.

The UE receives high-level signalling configuration to obtain the power control parameter for each uplink and downlink frequency domain resource distribution, for example, as shown in Table 3, when the uplink and downlink frequency domain resource distribution state is the first uplink and downlink frequency domain resource distribution state, the parameter P_{0_UE_PUSCH,b,f,c}_1 may be used for power control, and when the uplink and downlink frequency domain resource distribution state is the second uplink and downlink frequency domain resource distribution state, the parameter P_{0_UE_PUSCH,b,f,c}_2 may be used for power control.

TABLE 3
correspondence table between uplink and downlink frequency
domain resource distribution and power control parameter

| first uplink and downlink | second uplink and downlink |
|---|---|
| frequency domain resource | frequency domain resource |
| distribution state | distribution state |
| P₀_{_{—}}_{UE}_{_{—}}_{PUSCH, b, f, c —}1 | P₀_{_{—}}_{UE}_{_{—}}_{PUSCH, b, f, c —}2 |

It may be understood that the uplink and downlink frequency resource configuration for the PUSCH may also be determined by other signalling than configuration and activation scheduling information for scheduling CG PUSCH resource. For example, the UE may obtain the uplink and downlink frequency domain resource distribution state of the PUSCH by receiving semi-static signalling, for example, high-level signalling.

In an embodiment, the power control parameter may be determined based on the information related to the uplink and downlink frequency resource configuration for the PUSCH, where the indication is received via high-level signalling, otherwise other methods for determining the power control parameter may be used.

In another embodiment, the indication received via high-level signalling may include information related to a corresponding relationship used to indicate association between the uplink and downlink frequency resource configuration and the power control parameter. According to another embodiment, the indication received via high-level signalling may include indication used to indicate that the power control parameter is determined based on the information related to the uplink and downlink frequency resource configuration for the PUSCH. The indication may be 1-bit information.

For example, one of the following Mode 3 or Mode 4 may be selected for power control.

Mode 3. Determining the power for transmitting the PUSCH based on the determined uplink and downlink frequency domain resource distribution state in conjunction with configuration and activation scheduling information for the PUSCH resource.

Mode 4. Determining the power for transmitting the PUSCH based on configuration and activation scheduling information for the PUSCH resource.

For example, the UE may receive, via high-level signalling, the corresponding relationship as described above and shown in Table 3, then the UE may perform power control according to Mode 3. If the UE does not receive the corresponding relationship as shown in Table 3, the UE performs power control according to Mode 4.

For example, if the UE receives the indication used to indicate determining the power control parameter based on the information related to the uplink and downlink frequency resource configuration for the PUSCH, for example, indicating a configuration in which the power for transmitting the PUSCH is determined based on the determined uplink and downlink frequency domain resource distribution state in conjunction with the configuration and activation scheduling information for the PUSCH resource, then the power for transmitting the PUSCH is determined based on the determined uplink and downlink frequency domain resource distribution state in conjunction with the configuration and activation scheduling information for the PUSCH resource. If the UE does not receive the configuration in which the power for transmitting the PUSCH is determined based on the determined uplink and downlink frequency domain resource distribution state in conjunction with the configuration and activation scheduling information for the PUSCH resource, then the power for transmitting the PUSCH may be determined based on the configuration and activation scheduling information for the PUSCH resource. The indication may be 1-bit information. For example, when the indication is 0, the power for transmitting the PUSCH may be determined based on the determined uplink and downlink frequency domain resource distribution state in conjunction with the configuration and activation scheduling information for the PUSCH resource (Mode 3); when the indication is 1, the power for transmitting the PUSCH may be determined based on the configuration and activation scheduling information for the PUSCH resource (Mode 4).

It may be understood that the method for determining a power control parameter used by the PUSCH scheduled by the DCI and the method for determining a power control parameter used by the CG PUSCH may be determined independently.

The method for determining a power control parameter used by the PUSCH scheduled by the DCI is determined by a first signalling, for example, it may be determined by the first signalling that the PUSCH scheduled by the DCI applies the method of Mode 2 for determining a power control parameter. Of course, the power control parameter used by the PUSCH scheduled by the DCI may also be predefined.

The method for determining a power control parameter used by the CG PUSCH is determined by a second signalling, for example, it may be determined by the second signalling that the CG PUSCH applies the method of Mode 3 for determining a power control parameter. Of course, the power control parameter used by the CG PUSCH may also be predefined.

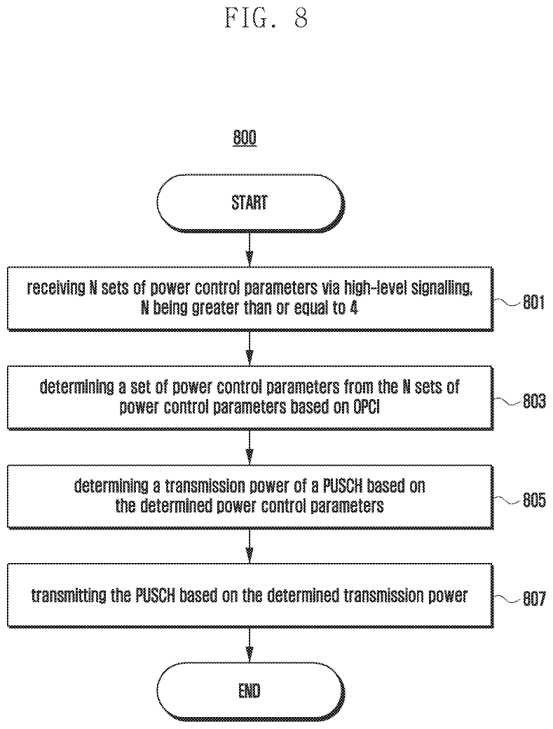

FIG. 8 is a flowchart of a method performed by a user equipment, according to an embodiment of the disclosure.

In a method 800 as shown in FIG. 8, in operation 801, receiving N sets of power control parameters via high-level signalling, N being greater than or equal to 4; in operation 803, determining a set of power control parameters from the N sets of power control parameters based on open-loop power control parameter set indication (OPCI); in operation 805, determining a transmission power of a PUSCH based on the determined power control parameters; and in operation 807, transmitting the PUSCH based on the determined transmission power. According to an embodiment, the OPCI may be 2 bits or 3 bits.

By using the method of the embodiment, the open-loop power control parameter set indication OPCI may contain a greater amount of information, and by controlling, through the OPCI, the power for the UE to transmit the PUSCH, the UE can determine the power for transmitting the PUSCH more reasonably.

According to an embodiment, when the OPCI is 2 bits, a mapping relationship between the OPCI and the open-loop power control parameter may be as shown in Table 4. In this case, the UE may receive 4 sets of power control parameters via high-level signalling, and select one from the 4 sets of parameters as the power control parameter of the PUSCH based on the OPCI. For example, when the OPCI is 11, the power control parameter is the third value of P0-PUSCH-Set.

TABLE 4
correspondence table between OPCI and power control parameter

| OPCI | power control parameter |
|---|---|
| 00 | a first P0-PUSCH-AlphaSet |
| 01 | a first value in P0-PUSCH-Set |
| 10 | a second value in P0-PUSCH-Set |
| 11 | a third value in P0-PUSCH-Set |

According to another embodiment, when the OPCI is 3 bits, a mapping relationship between the OPCI and the open-loop power control parameter may be as shown in Table 5. In this case, the UE may receive 6 sets of power control parameters via high-level signalling, and select one of the 6 sets of parameters as the power control parameter of the PUSCH based on the OPCI.

TABLE 5
correspondence table between OPCI and power control parameter

| OPCI | power control parameter |
|---|---|
| 000 | a first P0-PUSCH-AlphaSet |
| 001 | a first value in P0-PUSCH-Set |
| 010 | a second value in P0-PUSCH-Set |
| 011 | a third value in P0-PUSCH-Set |
| 100 | a fourth value in P0-PUSCH-Set |
| 101 | a fifth value in P0-PUSCH-Set |
| 110 | reserved |
| 111 | reserved |

Through the embodiment, the transmission power of the PUSCH can be controlled based on whether the interference caused by PUSCH transmission from other UEs is already on resources transmitting the PUSCH, and whether the PUSCH resource is in the first uplink and downlink frequency domain resource distribution state or the second uplink and downlink frequency domain resource distribution state.

The above method described in the disclosure may be performed by a UE including a transceiver and a processor.

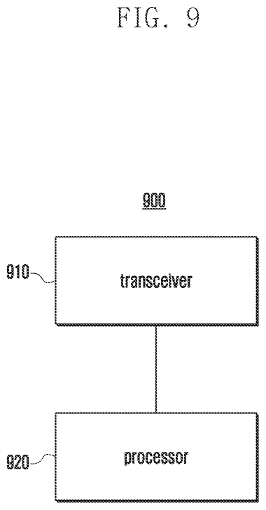

FIG. 9 illustrates a structure of a UE 900 according to an embodiment of the disclosure.

Referring to FIG. 9, the UE 900 includes a transceiver 910 and a processor 920 coupled to the transceiver 910. The transceiver 910 is configured to transmit signals and receive signals. The processor 920 is configured to perform one or more operations as described above in conjunction with specific embodiments, thereby causing the UE to perform the method performed by the UE as described in the disclosure. For example, the processor 920 is configured to: determine a power control parameter, based on information on uplink and downlink frequency resource configuration for a PUSCH; determine a transmission power of the PUSCH, based on the determined power control parameter; and transmit the PUSCH based on the determined transmission power.

The disclosure may also be implemented as a computer storage medium. The computer storage medium stores computer instructions therein. The computer instructions, when executed by the processor 920 of the UE 900, cause the processor 920 to perform one or more operations as described above in conjunction with specific embodiments, thereby implementing the method performed by the UE described in the disclosure.

According to an embodiment of the disclosure, a method performed by a base station in a communication system may include: transmitting to a user equipment (UE) information on uplink and downlink frequency resource configuration for a physical uplink shared channel (PUSCH); and receiving the PUSCH from the UE. Here, the PUSCH is transmitted by the UE based on a transmission power determined by the information on the uplink and downlink frequency resource configuration for the PUSCH.

According to another embodiment of the disclosure, a method performed by a base station in a communication system may include: transmitting N sets of power control parameters to a user equipment (UE) via high-level signalling, N being greater than or equal to 4; transmitting open-loop power control parameter set indication (OPCI) to the UE; and receiving a physical uplink shared channel (PUSCH) from the UE. Here, the PUSCH is transmitted by the UE based on a transmission power determined by a power control parameter indicated by the OPCI.

The above method described in the disclosure may be performed by a base station including a transceiver and a processor. The base station may include a transceiver and a processor coupled to the transceiver. The transceiver is configured to transmit signals and receive signals. The processor is configured to perform one or more operations as described above in conjunction with specific embodiments, thereby causing the base station to perform the method performed by the base station as described in the disclosure. For example, the processor is configured to: transmitting to a user equipment (UE) information on uplink and downlink frequency resource configuration for a physical uplink shared channel (PUSCH); and receiving the PUSCH from the UE.

The disclosure may also be implemented as a computer storage medium. The computer storage medium stores computer instructions therein. The computer instructions, when executed by the processor of the base station, cause the processor to perform one or more operations as described above in conjunction with specific embodiments, thereby implementing the method performed by the base station described in the disclosure.

It can be understood that “at least one” described in the disclosure includes any and/or all possible combinations of the listed items, the various embodiments described in the disclosure and the various examples in the embodiments may be varied and combined in any suitable form, and “/” described in the disclosure represents “and/or.”

The various illustrative logical blocks, modules, and circuits described in the disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. The general purpose processor may be a microprocessor, but in an alternative scheme, the processor may be any conventional processor, controller, microcontroller, or state machine. The processor may alternatively be implemented as a combination of computing devices, for example, a combination of a DSP and a microprocessor, a plurality of microprocessors, one or more microprocessors in collaboration with a DSP core, or any other such configuration.

The steps of the method or algorithm described in the disclosure may be embodied directly in hardware, in a software module executed by the processor, or in a combination of the two. The software module may reside in a RAM memory, a flash memory, a ROM memory, an erasable programmable read only memory (EPROM), an electrically erasable programmable read only memory (EEPROM), a register, a hard disk, a removable disk, or any other form of storage medium known in the art. A storage medium is coupled to the processor, to enable the processor to read information from/write information to the storage medium. In an alternative scheme, the storage medium may be integrated to the processor. The processor and the storage medium may reside in an ASIC. The ASIC may reside in a user terminal. In an alternative scheme, the processor and the storage medium may reside as discrete components in a user terminal.

In one or more designs, the functions described may be implemented in hardware, software, firmware, or any combination thereof. If implemented in software, the functions may be stored on or transmitted over a computer readable medium as one or more instructions or code. The computer readable medium includes both a computer storage medium and a communication medium, the communication medium including any medium that facilitates the transfer of a computer program from one place to another. The storage medium may be any available medium that can be accessed by a general purpose or special purpose computer.

Example configurations, methods and apparatuses are described in combination with the accompanying drawings in description set forth herein, and do not represent all the examples that may be implemented or that are within the scope of the claims. The term “exemplary” used herein means “serving as an example, instance, or illustration,” rather than “preferred” or “advantageous over other examples.” The detailed description includes specific details for the purpose of providing an understanding of the described techniques. These techniques, however, may be practiced without these specific details. In some instances, well-known structures and devices are shown in the form of a block diagram in order to avoid obscuring the concepts of the described examples.

This specification contains many specific implementation details, but the implementation details should not be construed as a limitation to the scope of any disclosure or the scope claimed, but rather as a description for specific features in a specific embodiment of the specific disclosure. Certain features described in the context of separate embodiments in this specification may alternatively be implemented in combination in a single embodiment. Rather, the various features described in the context of a single embodiment may be implemented separately in a plurality of various embodiments or implemented in any suitable sub-combination. Furthermore, the features may be described as functioning in certain combinations in the context, and even initially so claimed, but in some cases one or more features in a claimed combination may be deleted from the combination, and the claimed combination may be directed to a sub-combination or the variation of the sub-combination.

It is to be understood that the specific order or hierarchy of steps in the method in the disclosure is an illustration for a process. Based on design preferences, it may be understood that the specific order or hierarchy of the steps in the method may be rearranged to achieve the functions and effects disclosed in the disclosure. The accompanying method claims present the elements of various steps in example order, but are not intended to be limited to the specific order or hierarchy presented, unless specifically stated otherwise. Furthermore, although an element may be described or claimed in a singular form, the plural can also be expected unless the limitation to the singular is explicitly stated. Thus, the disclosure is not limited to the examples shown, and any apparatus for performing the functions described herein is included in the aspects of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, first information on an uplink and downlink frequency resource configuration for a physical uplink shared channel (PUSCH);
determining a power control parameter based on the first information on the uplink and downlink frequency resource configuration for the PUSCH;
determining a transmission power of the PUSCH based on the determined power control parameter; and
transmitting, to the base station, the PUSCH based on the determined transmission power.

2. The method of claim 1,
wherein the first information on the uplink and downlink frequency resource configuration for the PUSCH comprises an uplink and downlink frequency domain resource distribution state of the PUSCH, and
wherein the transmission power of the PUSCH is determined based on the uplink and downlink frequency domain resource distribution state of the PUSCH and scheduling information for the PUSCH.

3. The method of claim 1, further comprising:
receiving, from the base station, second information indicating an association between the uplink and downlink frequency resource configuration and the power control parameter,
wherein the power control parameter is determined based on the second information.

4. The method of claim 3, further comprising:
receiving, from the base station, third information on an index value,
wherein the index value comprises at least one of a sounding reference signal (SRS) resource indicator (SRI) field value, or open-loop power control parameter set indication (OPCI) field value.

5. A method performed by a base station in a wireless communication system, the method comprising:
transmitting, to a terminal, first information on an uplink and downlink frequency resource configuration for a physical uplink shared channel (PUSCH); and
receiving, from the terminal, the PUSCH based on a transmission power of the PUSCH,
wherein a power control parameter is determined based on the first information on the uplink and downlink frequency resource configuration for the PUSCH, and
wherein the transmission power of the PUSCH is determined based on the determined power control parameter.

6. The method of claim 5,
wherein the first information on the uplink and downlink frequency resource configuration for the PUSCH comprises an uplink and downlink frequency domain resource distribution state of the PUSCH, and
wherein the transmission power of the PUSCH is determined based on the uplink and downlink frequency domain resource distribution state of the PUSCH and scheduling information for the PUSCH.

7. The method of claim 5, further comprising:
transmitting, to the terminal, second information indicating an association between the uplink and downlink frequency resource configuration and the power control parameter; and
transmitting, to the terminal, third information on an index value,
wherein the power control parameter is determined based on the second information, and
wherein the index value comprises at least one of a sounding reference signal (SRS) resource indicator (SRI) field value, or open-loop power control parameter set indication (OPCI) field value.

8. A terminal in a wireless communication system, the terminal comprising:
a transceiver; and
at least one processor coupled with the transceiver and configured to:
receive, from a base station, first information on an uplink and downlink frequency resource configuration for a physical uplink shared channel (PUSCH),
determine a power control parameter based on the first information on the uplink and downlink frequency resource configuration for the PUSCH,
determine a transmission power of the PUSCH based on the determined power control parameter, and
transmit, to the base station, the PUSCH based on the determined transmission power.

9. The terminal of claim 8,
wherein the first information on the uplink and downlink frequency resource configuration for the PUSCH comprises an uplink and downlink frequency domain resource distribution state of the PUSCH, and
wherein the transmission power of the PUSCH is determined based on the uplink and downlink frequency domain resource distribution state of the PUSCH and scheduling information for the PUSCH.

10. The terminal of claim 8, wherein the at least one processor is further configured to:
receive, from the base station, second information indicating an association between the uplink and downlink frequency resource configuration and the power control parameter,
wherein the power control parameter is determined based on the second information.

11. The terminal of claim 8, wherein the at least one processor is further configured to:
receive, from the base station, third information on an index value,
wherein the index value comprises at least one of a sounding reference signal (SRS) resource indicator (SRI) field value, or open-loop power control parameter set indication (OPCI) field value.

12. A base station in a wireless communication system, the base station comprising:
a transceiver; and
at least one processor coupled with the transceiver and configured to:
transmit, to a terminal, first information on an uplink and downlink frequency resource configuration for a physical uplink shared channel (PUSCH), and
receive, from the terminal, the PUSCH based on a transmission power of the PUSCH,
wherein a power control parameter is determined based on the first information on the uplink and downlink frequency resource configuration for the PUSCH, and
wherein the transmission power of the PUSCH is determined based on the determined power control parameter.

13. The base station of claim 12,
wherein the first information on the uplink and downlink frequency resource configuration for the PUSCH comprises an uplink and downlink frequency domain resource distribution state of the PUSCH, and
wherein the transmission power of the PUSCH is determined based on the uplink and downlink frequency domain resource distribution state of the PUSCH and scheduling information for the PUSCH.

14. The base station of claim 12, wherein the at least one processor is further configured to:
transmit, to the terminal, second information indicating an association between the uplink and downlink frequency resource configuration and the power control parameter,
wherein the power control parameter is determined based on the second information.

15. The base station of claim 12, wherein the at least one processor is further configured to:
transmit, to the terminal, third information on an index value,
wherein the index value comprises at least one of a sounding reference signal (SRS) resource indicator (SRI) field value, or open-loop power control parameter set indication (OPCI) field value.
